(19) United States
(12) Patent Application Publication
(10) Pub. No.: US 2005/0286080 A1
(43) Pub. Date: Dec. 29, 2005

(54) Apparatus and method of transmitting document

(75) Inventors: Joong-mok Lee, Anyang-si (KR); Kee-taek Kim, Seoul (KR); Hyun-wook Park, Gwacheon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/167,741

(22) Filed: Jun. 28, 2005

(30) Foreign Application Priority Data
Jun. 29, 2004 (KR) 10-2004-0049708
Jul. 8, 2004 (KR) 10-2004-0052985
Sep. 20, 2004 (KR) 10-2004-0075059

(51) Int. Cl. G06F 15/00

(52) U.S. Cl. 358/1.15

(57) ABSTRACT

An apparatus and method of transmitting a document between Multi-Function Products (MFPs) via a network, in which an MFP groups client devices and transmits a document to a plurality of client devices that belong to each group. When a plurality of image forming devices are connected to one another through a network, the apparatus includes a scanning portion for scanning a document and producing image data, a user interface for selecting a command for performing a function or a desired image forming device, a network interface connected to the image forming devices over the network for transmitting the scanned document to the selected image forming device, a display portion, and a controller for controlling the display portion to display information about the image forming devices existing on the network and transmitting the scanned image data to the selected image forming device via the network.

### CROSS-REFERENCE TO RELATED APPLICATIONS

This application claims the benefit under 35 U.S.C. §119(a) of Korean Patent Application No. 10-2004-0049708 filed in the Korean Intellectual Property Office on Jun. 29, 2004, Korean Patent Application No. 10-2004-0052985 filed in the Korean Intellectual Property Office on Jul. 8, 2004, and Korean Patent Application No. 10-2004-0075059 filed in the Korean Intellectual Property Office on Sep. 20, 2004, the entire disclosures of which are incorporated herein by reference.

### BACKGROUND OF THE INVENTION

1. Field of the Invention

The present invention relates to an apparatus and method of transmitting a document between Multi-Function Products (MFPs) via a network. More specifically, the present invention relates to an apparatus and method of transmitting a document between Multi-Function Products (MFPs) via a network, in which an MFP groups client devices and transmits a document to a plurality of client devices that belong to each group.

2. Description of the Related Art

Generally, multi-function products (MFPs) are office automation apparatuses which perform multiple functions, such as printing, copying, scanning, and facsimile operations, thereby providing the user with a complete office solution in one compact device.

FIG. 1 is a block diagram of a structure of a conventional document transceiving apparatus, which may be used with not only the above-stated MFPs, but also with general digital copiers or scanners. The document transceiving apparatus of FIG. 1 is shown being used with at least one MFP.

In FIG. 1, a first MFP 108 is connected to a first personal computer (PC) 106. A second MFP 109 is connected to a second PC 107. A third MFP 110 is connected to the second MFP 109 via a public switched telephone network (PSTN) 101. The first through third MFPs 108, 109, and 110, and a fourth MFP 111, are each connected to the Internet 100 via first and second hubs 104 and 105. The first, second, third, and fourth MFPs 108, 109, 110, and 111, are also connected to first and second data servers 102 and 103 via the Internet 100. The first and second data servers 102 and 103 receive documents scanned by the first through fourth MFPs 108 through 111 via the Internet 100 and transmit the documents back to the first through fourth MFPs 108 through 111 in such a way that a document scanned by the first MFP 108 is transmitted to one of the MFPs other than the first MFP 108, and so forth.

Generally, a scanned document is used in methods such as Copy, PC-SCAN, SCAN-TO-Email/Memory/FTP (file transfer protocol), FAX, and the like. In a copying method, an MFP independently scans and prints a document. In PC-SCAN, an MFP scans a document and transmits the scanned document to a PC. In SCAN-TO-Memory, a scanned document is stored in an MFP. In contrast with the above-described operations, FAX is transmission of a document between separate MFPs. A FAX can be considered the most traditional method of transmitting a document between MFPs. In another method of transmitting a document between MFPs, an MFP scans a document and transmits the scanned document to a data server, the data server transmits the scanned document to another MFP, and the latter MFP prints the scanned document.

When MFPs transmit a document to each other using the FAX method, a slow transmission speed, low resolution, and high costs due to the use of telephone lines are caused because of the characteristics of the FAX method. When a document is transmitted between MFPs using a data server, however, the data server construction is needed, which generates an additional cost. When a document is transceived using a server, a printing implementation becomes complicated.

The MFPs (for example, the first through fourth MFPs 108 through 111) are constructed to communicate with the client devices (for example, the first and second PCs 106 and 107) via the networks (for example, the Internet 100 and the PSTN 101). In a scanning function of an MFP over a network, a user who wants to scan a document searches for a desired MFP by executing a network scan client application in his or her own device, that is, a client device (for example, the first PC 106). The user finds the desired MFP ( for example, the fourth MFP 111) and registers his or her identifier (ID) and password (PW) in the fourth MFP 111. Thereafter, the user inputs his or her ID and PW to the fourth MFP 111 and scans a document. At this time, the scanned document image is transmitted to the first PC 106, which is a user's device, via the PSTN 101 and is stored in the first PC 106.

In such a conventional document transceiving apparatus, an MFP is supposed to transmit a scanned document image to a single client device. Hence, to transmit an identical scanned document image to a plurality of client devices, an identical scanning operation must be repeated several times, or the identical scanned document image must be re-transmitted using another network means, for example, E-mail.

Accordingly, a need exists for a system and method for transmitting a document, in which an MFP can transmit a document to a plurality of client devices.

### SUMMARY OF THE INVENTION

The present invention provides an apparatus and method of transmitting a document using a network, by which a transmission-side Multi-Functional Product (MFP) transmits scanned document data to a reception-side MFP via a network.

The present invention also provides an apparatus and method of transmitting a document, in which MFPs can share information through a network, and wherein an MFP can transmit a scanned document to another MFP and store the scanned document in the MFP.

The present invention also provides an apparatus and method of transmitting a document, in which client devices are grouped and scanned document data is transmitted to several client devices included in each group through one scanning operation without a need to scan the document several times to transmit the scanned document to several client devices.

According to an aspect of the present invention, a document transmitting apparatus is provided comprising a plurality of image forming devices connected to one another through a network. The apparatus further comprises a scanning portion for scanning a document and producing image data, a user interface for selecting a command for performing a function or a desired image forming device, a network interface connected to the image forming devices over the network for transmitting the scanned document to the selected image forming device, a display portion, and a controller for controlling the display portion to display information about the image forming devices existing on the network and transmitting the scanned image data to the selected image forming device via the network.

According to another aspect of the present invention, an apparatus is provided for transmitting scanned document data to an image forming device selected from reception-side image forming devices existing over a network. The apparatus comprises a user interface for receiving a command to transmit the scanned document data to the reception-side image forming devices, a command to set addresses for the reception-side image forming devices, and a command to select image forming devices to receive the scanned document data. The apparatus further comprises a network interface for transmitting scanned image data that the reception-side image forming devices can process to the selected image forming devices. The apparatus still further comprises a controller for controlling the apparatus to store the addresses of the reception-side image forming devices received via the user interface and information about the printer languages processible by the reception-side image forming devices received via the network interface, and to transmit the encoded scanned document data to the selected reception-side image forming devices via the network.

According to another aspect of the present invention, an apparatus is provided for transmitting scanned document data to an image forming device selected from the reception-side image forming devices over a network. The apparatus comprises a user interface for receiving a command to transmit the scanned document data to the reception-side image forming devices, a command to set addresses for the reception-side image forming devices, a command to set printer languages processible by the reception-side image forming devices, and a command to select a reception-side image forming device to receive the scanned document data. The apparatus further comprises a network interface for transmitting scanned document data encoded in the processible printer languages to the selected image forming device, a data production and processing portion for encoding the scanned document data in the printer language processible by the selected image forming device. The apparatus still further comprises a controller for controlling the apparatus to store information about the addresses of the reception-side image forming devices and the printer languages processible by the reception-side image forming devices, which is received via the user interface, and to transmit the encoded scanned document data to the selected reception-side image forming device via the network.

According to another aspect of the present invention, a document transmitting apparatus is provided which is comprised of an image forming device that communicates with client devices via a network. The apparatus is comprised of a first database for storing identifiers, passwords, and group identifiers of the client devices input by clients, an input portion for receiving an identifier of a group to receive scanned document data, a second database for storing a transmission list of client devices to actually receive scanned document data, and a transmission portion for simultaneously transmitting the scanned document data to all of the client devices included in the transmission list. The apparatus is further comprised of a controller for controlling the apparatus to produce the transmission list from client devices that have replied to a query message transmitted before the transmission of the scanned document data from among client devices having the received group ID and store the transmission list in the second database, to transmit some of the scanned document data to all of the client devices included in the transmission list when scanning starts, to delete client devices that have not sent a response informing of a reception of the partial scanned document data from the second database, and to transmit the remaining scanned document data to client devices that have sent the response.

According to another aspect of the present invention, a document transmitting method is provided comprising the steps of receiving a user command for image forming devices existing over a network to print or store a scanned document, displaying information about the image forming devices and receiving a signal for selecting an image forming device to print or store the scanned document from the image forming devices over the network, receiving a signal for selecting options necessary for printing the scanned document from among the information or authenticating storage of the scanned document, and scanning the document and transmitting the document to the selected image forming device.

According to another aspect of the present invention, a method is provided of transmitting scanned document data to an image forming device selected from the reception-side image forming devices existing over a network, the method comprising the steps of setting addresses for the reception-side image forming devices, receiving processible printer languages from the reception-side image forming devices via the network, receiving a signal for selecting a reception-side image forming device to which the scanned document data is to be transmitted from among the reception-side image forming devices existing over the network, and encoding a scanned document in printer languages processible by the selected reception-side image forming device and transmitting the encoded scanned document to the selected reception-side image forming device.

According to another aspect of the present invention, a method is provided of transmitting scanned document data to a reception-side image forming device selected from the reception-side image forming devices existing over a network, the method comprising the steps of receiving a signal for setting addresses for all of the reception-side image forming devices and a signal for setting printer languages processible by the reception-side image forming devices, receiving a signal for selecting a reception-side image forming device to which the scanned document data is to be transmitted from among the reception-side image forming devices existing over the network, and encoding a scanned document in printer languages processible by the selected reception-side image forming device and transmitting the encoded scanned document to the selected image forming device.

According to another aspect of the present invention, a document transmitting method is provided comprising the steps of receiving identifiers, passwords, and group identifiers of a plurality of client devices from a plurality of clients and grouping client devices that have an identical group identifier, and inputting an identifier of a group to receive scanned data and transmitting scanned document data to all client devices that belong to the group with the input group identifier when scanning starts.

### BRIEF DESCRIPTION OF THE DRAWINGS

The above and other features and advantages of the present invention will become more apparent by describing in detail exemplary embodiments thereof with reference to the attached drawings, in which:

FIG. 1 is a block diagram of a structure of a conventional document transmitting apparatus;

FIG. 2 is a block diagram of a structure of a document transmitting apparatus according to an exemplary embodiment of the present invention;

FIG. 3 is a block diagram of a controller included in the document transmitting apparatus of FIG. 2;

FIG. 4 a block diagram of a structure of a document transmitting apparatus according to another exemplary embodiment of the present invention;

FIG. 5 a block diagram of a structure of a document transmitting apparatus according to still another exemplary embodiment of the present invention;

FIG. 6 illustrates an example of a network scan client application for registering client devices in a Multi-Function Product (MFP) in FIG. 5 according to an embodiment of the present invention;

FIG. 7 illustrates an example of a transmission of scanned document data by an MFP to grouped client devices in FIG. 5 according to an embodiment of the present invention;

FIG. 8 is a flowchart illustrating a document transmitting method according to an embodiment of the present invention;

FIG. 9 is a flowchart illustrating an operation of executing authentication for document storage among operations illustrated in FIG. 8 according to an embodiment of the present invention;

FIGS. 10 and 11 are flowcharts illustrating a document transmitting method according to another embodiment of the present invention;

FIG. 12 is a flowchart illustrating a document transmitting method according to still another embodiment of the present invention; and

FIG. 13 is a flowchart illustrating an operation of transmitting scanned document data to a group of client devices among operations illustrated in FIG. 12.

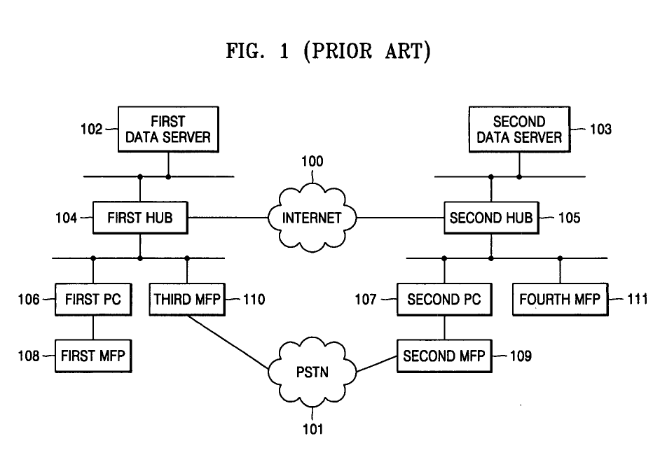

Throughout the drawings, like reference numerals will be understood to refer to like parts, components and structures.

### DETAILED DESCRIPTION OF THE EXEMPLARY EMBODIMENTS

The present invention will now be described in detail with reference to the accompanying drawings, in which exemplary embodiments of the present invention are shown.

A Multi-Function Product (MFP) in the embodiments of the present invention may include a scanning function, a copying function, a faxing function, a printing function, and the like.

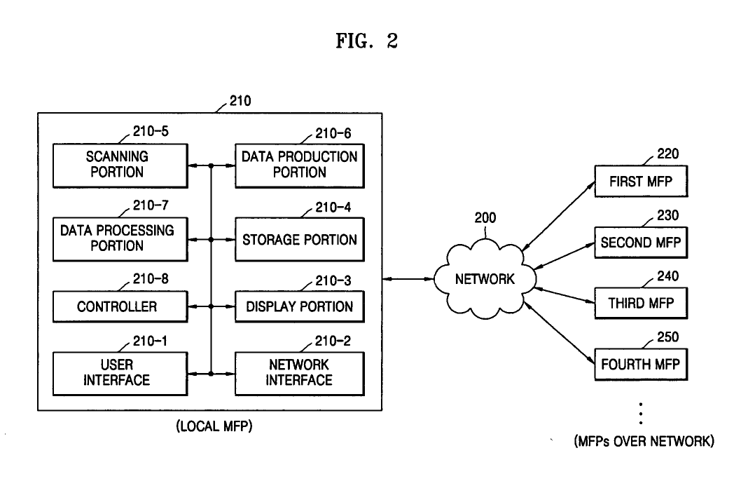

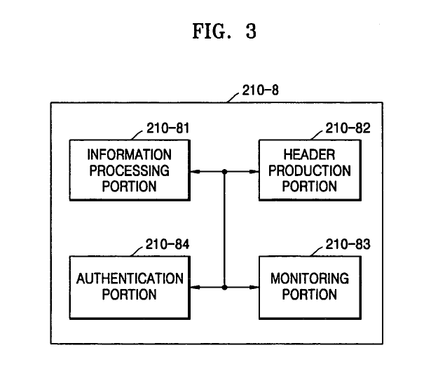

FIG. 2 is a block diagram of a structure of an apparatus for transmitting a document to a selected Multi-Function Product (MFP) according to an exemplary embodiment of the present invention. Referring to FIG. 2, the document transmitting apparatus is comprised of a network 200, a local MFP 210, and first through fourth MFPs 220 through 250. The first through fourth MFPs 220 through 250 are connected to the local MFP 210 via the Internet 200. The local MFP 210 includes a user interface 210-1, a network interface 210-2, a display portion 210-3, a storage portion 210-4, a scanning portion 210-5, a data production portion 210-6, a data processing portion 210-7, and a controller 210-8. As shown in FIG. 3, the controller 210-8 includes an information processing portion 210-81, a header production portion 210-82, a monitoring portion 210-83, and an authentication portion 210-84.

The local MFP 210 executes bidirectional communications with the first through fourth MFPs 220 through 250 (hereinafter, referred to as “MFPs”) via the network 200. In response to a request from the local MFP 210, the MFPs transmit their information to the local MFP 210. The local MFP 210 receives the information transmitted by the MFPs, selects at least one MFP, scans a document to be printed or stored, and transmits the scanned document to the selected MFP. The selected MFP receives the document to be printed or stored, and prints or stores the document.

More specifically, a key (not shown, and hereinafter referred to as a “remote key”) or a menu for transmitting the to-be-printed or to-be-stored document to the selected MFP, is added to the local MFP 210. The remote key can perform both a function in which the selected MFP prints a scanned document, and a function in which the selected MFP stores (copies) the scanned document.

The user interface 210-1 receives a user command for at least one of a plurality of MFPs existing over a network to print or store a document, that is, a remote key selection signal, and further receives a command to select a desired one from among the plurality of MFPs and predetermined information relating to the user command and the selection command. The predetermined information denotes a variety of information for document printing or storage and is described in greater detail below as option information.

The network interface 210-2 interfaces information transception between the local MFP 210 and the plurality of MFPs via the network 200. The network interface 210-2 transmits an information request signal to the plurality of MFPs, receives information about the MFPs transmitted by the MFPs, transmits an MFP selection signal to a corresponding MFP and a to-be-printed or to-be-stored scanned document to a selected MFP, and receives a signal indicating a result of the processing of the scanned document by the selected MFP.

The display portion 210-3 displays the information about the plurality of MFPs received via the network interface 210-2 under the control of the controller 210-8, and also displays an operation of the local MFP 210 that depends on the user command and the information received by the user interface 210-1.

The storage portion 210-4 stores the information about the plurality of MFPs received via the network interface 210-2 under the control of the controller 210-8. The information about the MFPs can include, but is not limited to, a list of MFPs capable of printing or storing a scanned document, state information about availability of the MFPs, information about options supported by the MFPs, information about locations in the MFPs where the document can be stored, and the like. The information about the options supported by the MFPs denotes information about the states of device options, such as paper sizes supported by the MFPs, page description languages supported by the MFPs, a double-sided printing function, a staple function, a punch function, and the like.

The scanning portion 210-5 scans a predetermined document under the control of the controller 210-8.

The data production portion 210-6 produces a scanned image from the document scanned by the scanning portion 210-5.

The data processing portion 210-7 produces new data to be transmitted to a selected MFP as a result of the processing of an option selected by the user interface 210-1 upon the scanned image received from the data production portion 210-6.

The new data produced by the data processing portion 210-7 is transmitted to the selected MFP via the network interface 210-2 under the control of the controller 210-8, and can then be printed by or stored in the selected MFP.

The control of the document printing and storage by the controller 210-8 will now be described in greater detail with reference to FIG. 3.

In response to a received printing or storage command, the controller 210-8 controls the local MFP 210 to display the information about the plurality of MFPs existing on the network 200, transform a scanned document so that a selected MFP can print or store the scanned document, and transmit the transformed scanned document to the selected MFP via the network.

When information is received from the plurality of MFPs by the selection of a remote key by a user using the user interface 210-1, an information processing portion 210-81 processes the information about the MFPs into displayable information. The processed information includes the information about the states of the MFPs regarding the capability of printing or storing a scanned document, the information about the options supported by the MFPs, the information about locations where the document is storable in the MFPs, and the like.

The processed information is displayed on the display portion 210-3 and stored in the storage portion 210-4. The user selects at least one MFP to print or store a scanned document through the user interface 210-1 with reference to the information about the MFPs displayed on the display portion 210-3.

If the selected MFP prints the scanned document, the controller 210-8 receives a signal for the selection of the option information for printing, such as paper sizes supported by the MFP, page description languages supported by the MFP, a double-sided printing function, a staple function, a punch function, and the like, and controls the data processing portion 210-7 to produce new data.

If the selected MFP stores the scanned document, the controller 210-8 receives a signal for the selection of information about document-storable locations in the MFP selected through the user interface 210-1, and controls the local MFP 210 to transmit a scanned document to a document-storable location within the selected MFP where the scanned document is to be stored.

A header production portion 210-82 produces a header indicating printing or storage, and adds the header to a scanned document to be transmitted to the selected MFP. If the selected MFP prints the scanned document, the header production portion 210-82 produces the selected option information as the header and controls the data processing portion 210-7 to produce new data.

A monitoring portion 210-83 monitors how the selected MFP, which has received the to-be-printed or to-be-stored document from the local MFP 210, prints or stores the document. The monitoring portion 210-83 periodically or non-periodically receives a printing or storage circumstance signal via the network interface 210-2 from the MFP which has received the scanned document and responds accordingly to the printing or storage circumstance corresponding to the printing or storage circumstance signal. For example, if the monitoring portion 210-83 receives a document-reception failure signal from the selected MFP, the controller controls the local MFP 210 to re-transmit the scanned document.

An authentication portion 210-84 operates upon the storage of a scanned document in a selected MFP. When a place to store the scanned document is selected, the authentication portion 210-84 requests a password input to authenticate the storage of the scanned document. When a password is input through the user interface 210-1, the authentication portion 210-84 authenticates the storage of the scanned document in the selected place if the input password is identical to a predetermined password. If the input password is not identical to the predetermined password, the authentication portion 210-84 outputs an error message and requests a password re-input.

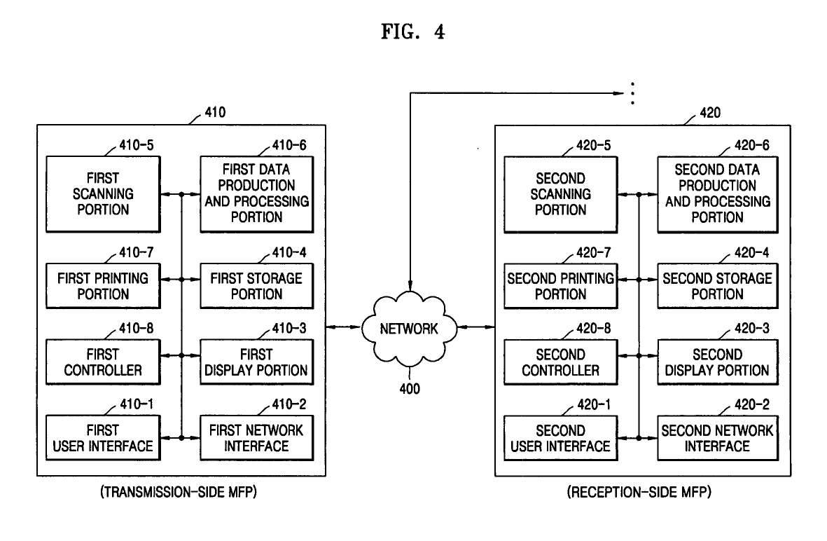

FIG. 4 is a block diagram of a structure of a document transmitting apparatus according to another exemplary embodiment of the present invention. The document transmitting apparatus of FIG. 4 is comprised of a network 400, a transmission-side MFP 410, and a reception-side MFP 420. The transmission-side MFP 410 includes a first user interface 410-1, a first network interface 410-2, a first display portion 410-3, a first storage portion 410-4, a first scanning portion 410-5, a first data production and processing portion 410-6, a first printing portion 410-7, and a first controller 410-8. The reception-side MFP 420 includes a second user interface 420-1, a second network interface 420-2, a second display portion 420-3, a second storage portion 420-4, a second scanning portion 420-5, a second data production and processing portion 420-6, a second printing portion 420-7, and a second controller 420-8.

To transmit a document using a network, the transmission-side MFP 410 preferably includes a scan function, and the reception-side MFP 420 preferably includes a printing function.

The document transmitting apparatus may include a plurality of reception-side MFPs 420 instead of a single reception-side MFP 420 as shown in FIG. 4.

The transmission-side MFP 410 executes bi-directional communications with the reception-side MFP 420 via the network 400, which includes a wire/wireless Internet.

To scan and transmit a document, the first user interface 410-1 receives a command to transmit scanned document data to another MFP, a command to set addresses for reception-side MFPs, and a command to select MFPs to receive the scanned document data.

The first network interface 410-2 interfaces information transception between the transmission-side MFP 410 and the reception-side MFP 420 via the network 400. The first network interface 410-2 requests information about processible printer languages, that is, page description languages (PDLs), from the reception-side MFPs 420 existing on the network 400 at the request of the first controller 410-8. In response to the request of the first network interface 410-2, the processible printer languages of the reception-side MFPs 420 are transmitted to the first network interface 410-2 via the network 400. Also, the first network interface 410-2 transmits encoded scanned document data to selected MFPs via the network 400 under the control of the first controller 410-8.

The first display portion 410-3 displays a process of transmitting a scanned document, under the control of the first controller 410-8.

Under the control of the first controller 410-8, the first storage portion 410-4 stores the address of the reception-side MFPs received via the first user interface 410-1 and information about the processible printer languages received from the MFPs.

The first scanning portion 410-5 scans a predetermined document to be transmitted, under the control of the first controller 410-8.

The first data production and processing portion 410-6 produces a scanned image from the document scanned by the first scan portion 410-5 and encodes the scanned image in a printer language processible by the selected reception-side MFP 420.

The first controller 410-8 controls an overall operation of the transmission-side MFP 410. The first controller 410-8 controls the transmission-side MFP 410 to store the addresses of the reception-side MFPs received via the first user interface 410-1 and the information about the printer languages processible by the reception-side MFPs received via the first network interface 410-2 in the first storage portion 410-4. At this time, the addresses of the reception-side MFPs can be grouped and stored on a group-by-group basis. Also, the first controller 410-8 controls the transmission-side MFP 410 to transmit the scanned image, which can be encoded differently according to the processible printer language by the first data production and processing portion 410-6, to the selected reception-side MFP via the network 400.

In an operation of the reception-side MFP 420, the second controller 420-8 controls the reception-side MFP 420 to transmit the information about the processible printer languages to the transmission-side MFP 410 via the second network interface 420-2 and the network 400 at the request of the transmission-side MFP 410. The second storage portion 420-4 stores the encoded scanned document data received from the transmission-side MFP 410 via the network 400. The second printing portion 420-7 prints the stored document data. Since the reception-side MFP 420 can also operate as the transmission-side MFP 410, other elements not described but included therein are substantially the same as those of the transmission-side MFP 410 and thus, will not be described herein.

Alternatively, when receiving the command to set the addresses of the reception-side MFPs, the first user interface 410-1 may also receive printer languages processible by the reception-side MFPs. The addresses of the reception-side MFPs and the processible printer languages are stored in the first storage portion 410-4. Hence, the transmission-side MFP 410 does not need to additionally request and receive the processible printer languages. The first controller 410-8 controls the transmission-side MFP 410 to transmit the encoded scanned document to the selected reception-side MFPs 420 via the network 400. These processes have already been described above, so they will not be described in greater detail.

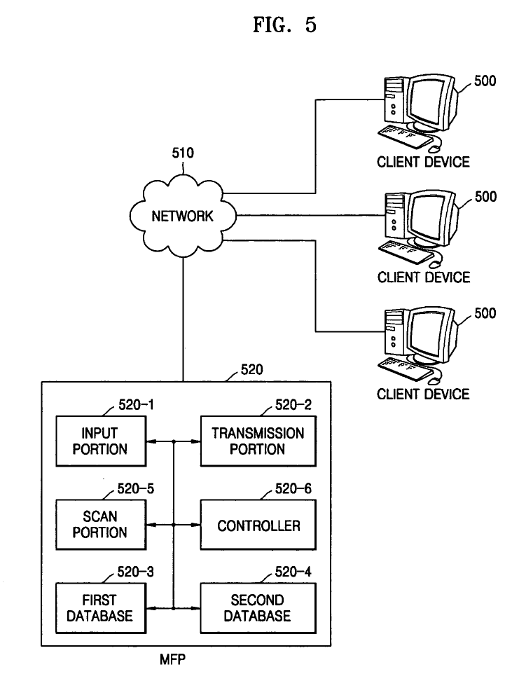

FIG. 5 is a block diagram of a structure of a document transmitting apparatus according to still another exemplary embodiment of the present invention. The document transmitting apparatus of FIG. 5 is comprised of a plurality of client devices 500, a network 510, and an MFP 520. The MFP 520 includes an input portion 520-1, a transmission portion 520-2, first and second databases 520-3 and 520-4, a scan portion 520-5, and a controller 520-6.

The MFP 520 can transmit scanned document data via the network 510 to the plurality of client devices 500 through one scanning operation, that is, without needing to scan a document several times to transmit to a plurality of client devices 500 in each group. The MFP 520, which can further perform a grouping function, will now be described in greater detail.

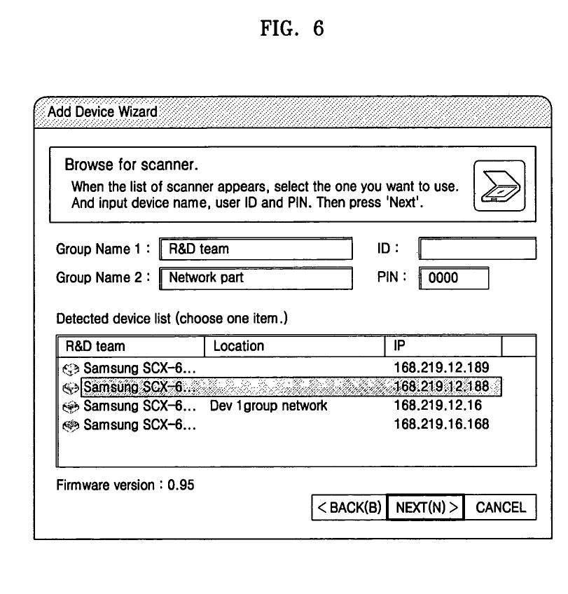

Clients search for a desired MFP 520 by executing a network scan client application as shown in FIG. 6 in their own devices 500, and input their IDs, PWs, and group IDs.

Thereafter, during scanning, the input portion 520-1 of the MFP 520 receives from clients the ID of a group to receive scanned document data.

The transmission portion 520-2 transmits the scanned document data to all client devices 500 belonging to the group with the received ID via the network 510 under the control of the controller 520-6.

The first database 520-3 stores the IDs and PWs input by the clients under the control of the controller 520-6 in such a way that the IDs and PWs of clients who input an identical group ID can be grouped.

The second database 520-4 stores a transmission list independently of the first database 520-3. The transmission list denotes a list of client devices 500 that have replied to a query message transmitted before the transmission of scanned data among each group of client devices 500 that are stored in the first database 520-3. After a part of the scanned data is transmitted to the client devices 500 stored in the second database 520-4, if some client devices 500 do not reply to the transmission of the scanned data within a predetermined period of time, these client devices 500 are detected from the transmission list under the control of the controller 520-6.

The scan portion 520-5 scans a document.

The controller 520-6 controls all operations of the MFP 520 and particularly, controls the MFP 520 to group client devices 500 having the group ID received by the input portion 520-1. The controller 520-6 controls the MFP 520 to produce the transmission list from the client devices 500 which have replied to the query message transmitted before transmission of the scanned data from among the client devices 500 belonging to the group to receive the scanned data. The controller 520-6 controls the MFP 520 to transmit some of the scanned data to all of the client devices 500 included in the transmission list, and the remaining scanned data to client devices 500 which have replied to the partial scanned data. However, as for client devices 500 which have not replied, the scanned data is repetitively transmitted to the non-replying client devices 500. Client devices 500 which still do not reply to the transmitted scanned data are then deleted from the transmission list.

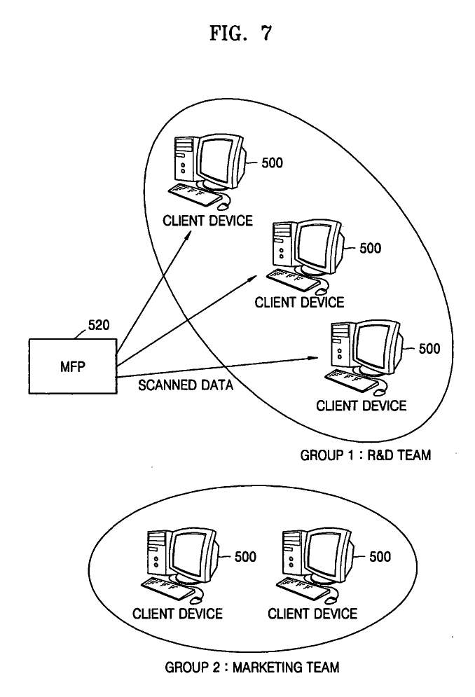

FIG. 7 illustrates an example of a transmission of scanned document data by the MFP 520 to groups of client devices 500. In this example, when the client devices 500 are classified into group 1 (such as an R&D team) and group 2 (such as a Marketing team), scanned data is transmitted to all client devices 500 belonging to the group 1 (that is, the R&D team).

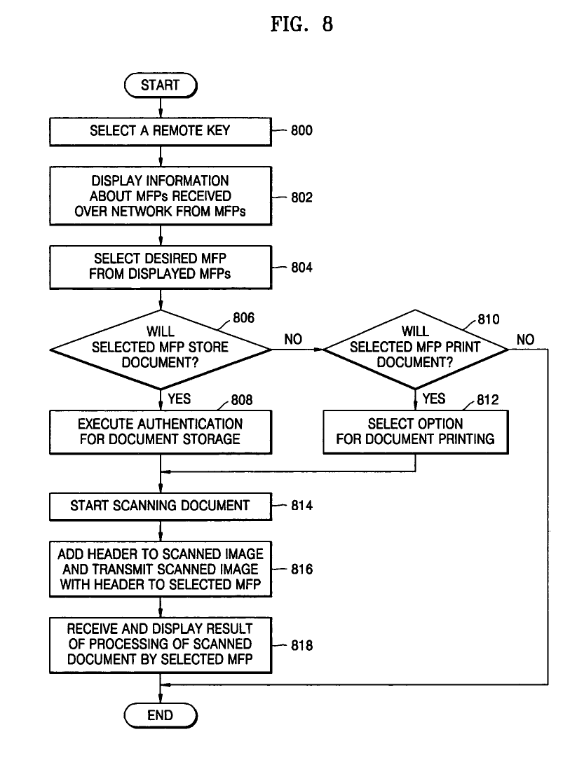

FIG. 8 is a flowchart illustrating a document transmitting method according to an embodiment of the present invention. The document transmitting method of FIG. 8 will now be described in greater detail in conjunction with FIGS. 2 and 3.

To print a document transmitted by an MFP using another MFP or store the same in another MFP, a user selects a remote key through the user interface 210-1, in operation 800. The local MFP 210 additionally includes a remote key or menu for printing a predetermined document using another MFP or storing the same therein.

When the remote key is selected, the controller 210-8 controls the display portion 210-3 to receive information about the plurality of MFPs over the network 200 via the network interface 210-2 and displays the same in operation 802. The network interface 210-2 transmits an information request signal to the plurality of MFPs over the network 200 under the control of the controller 210-8 and receives the information about the MFPs from the MFPs, such as a list of MFPs capable of printing or storing a scanned document, state information about the availability of the MFPs, information about options supported by the MFPs, information about document-storable locations within the MFPs, and the like. The information processing portion 210-81 processes the information about the MFPs into displayable information and outputs the displayable information to the display portion 210-3.

In operation 804, an MFP for printing or storing a document is selected by a user using the user interface 210-1 by referring to the displayable information about the MFPs.

When the selection of an MFP is completed, the user inputs through the user interface 210-1 whether a selected MFP is to store or print a document according to a received user command.

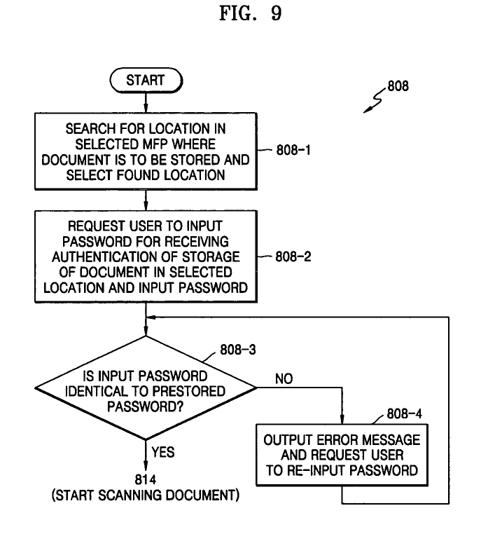

If it is determined in operation 806 that the selected MFP is to store the document, authentication for document storage is performed in operation 808. FIG. 9 illustrates an example of the authentication for document storage and is described in greater detail below.

Referring to FIG. 9, when the selected MFP stores a document, the user searches for a location in the selected MFP where the document is to be stored from the information about the selected MFP displayed on the display portion 210-3 and selects the location using the user interface 210-1 in operation 808-1.

When the location where the document is to be stored is selected, the authentication portion 210-84 requests the user to input a password for receiving an authentication of storage of the document in the selected location and the user inputs a password through the user interface 210-1 in operation 808-2.

If it is determined in operation 808-3 that the password input through the user interface 210-1 is identical to a pre-stored password, the storage of the document in the selected location is authenticated and the document starts being scanned.

If it is not determined in operation 808-3 that the password input through the user interface 210-1 is identical to the pre-stored password, the authentication portion 210-84 outputs an error message and requests the user to re-input a password in operation 808-4. At the request of the authentication portion 210-84 for password re-input, the user re-inputs another password through the user interface 210-1 to receive an authentication of the storage of the document in the selected location.

Referring back to FIG. 8, if it is determined in operation 810 that the selected MFP is to print the document, an option for document printing is selected through the user interface 210-1 in operation 812. For example, a desired option can be selected from among options including paper sizes supported by the selected MFP, page description languages supported by the selected MFP, a double-sided printing function, a staple function, a punch function, and the like.

After an option for document printing by the selected MFP is selected, or the storage of the document in the selected MFP is authenticated, the scanning portion 210-5 starts scanning the document, and the data production portion 210-6 produces a scanned image from the document scanned by the scanning portion 210-5 in operation 814.

In operation 816, the header production portion 210-82 adds header information to the scanned image and transmits the resultant scanned image to the selected MFP via the network interface 210-2. If the selected MFP is to print the scanned document, the header production portion 210-82 produces information about the selected option as the header and controls the data processing portion 210-7 to produce new data. If the selected MFP is to store the scanned document, the header production portion 210-82 produces information about the selected location where the document is to be stored as the header and controls the data processing portion 210-7 to produce new data.

After the scanned document is transmitted to the selected MFP, the monitoring portion 210-83 receives a result of the processing of the scanned document by the selected MFP and displays the processing result on the display portion 210-3 in operation 818. The monitoring portion 210-83 periodically or non-periodically receives a printing or storage circumstance signal via the network interface 210-2 from the MFP which has received the scanned document and responds accordingly to the printing or storage circumstance indicated by the printing or storage circumstance signal.

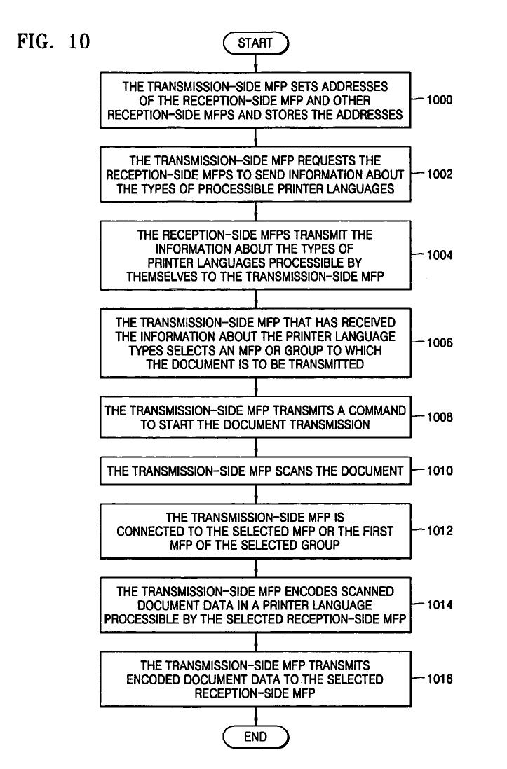

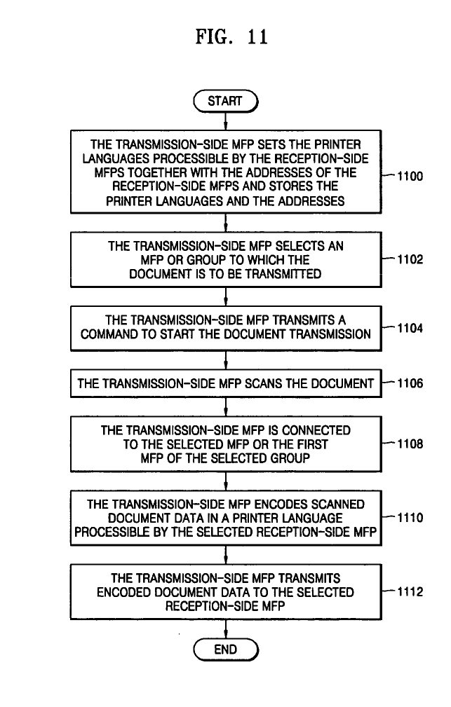

FIGS. 10 and 11 are flowcharts illustrating a document transmitting method according to another embodiment of the present invention. The document transmitting method of FIGS. 10 and 11 will now be described in greater detail in conjunction with FIG. 4.

Referring to the method of FIG. 10, the transmission-side MFP 410 sets addresses of the reception-side MFP 420 and other reception-side MFPs (hereinafter, collectively referred to as “reception-side MFPs 420”) and stores the addresses in the first storage portion 410-4 in operation 1000. At this time, the transmission-side MFP 410 can divide the plurality of reception-side MFPs 420 into at least one group.

Thereafter, the transmission-side MFP 410 requests the reception-side MFPs 420 to send information about the types of processible printer languages via the network 400 in operation 1002.

At the request of the transmission-side MFP 410, the reception-side MFPs 420 transmit the information about the types of printer languages processible by the reception-side MFPs 420 to the transmission-side MFP 410 via the network 400 in operation 1004.

In operation 1006, the transmission-side MFP 410 that has received the information about the printer language types, selects an MFP or group to which the document is to be transmitted.

When the MFP or group to which the document is to be transmitted is selected, a command to start the document transmission is issued in operation 1008. The first scanning portion 410-5 then scans the document in operation 1010.

Then, the transmission-side MFP 410 is connected to the selected MFP 420 or the first MFP of the selected group in operation 1012.

The scanned document data is encoded in a printer language processible by the selected reception-side MFP 420 in operation 1014.

Thereafter, the encoded document data is transmitted to the selected reception-side MFP 420 via the network 400 in operation 1016. Operations 1012 through 1016 are then repeated to transmit the scanned document data to all of the reception-side MFPs 420 belonging to each group.

Referring to the method of FIG. 11, the transmission-side MFP 410 sets the printer languages processible by the reception-side MFPs 420 together with the addresses of the reception-side MFPs 420, and stores the printer languages and the addresses in the first storage portion 410-4 in operation 1100. In contrast with the method of FIG. 10 in which the transmission-side MFP 410 requests from the reception-side MFPs 420 the printer languages processible by the reception-side MFPs 420, the transmission-side MFP 410 implementing the method of FIG. 11 also sets the printer languages processible by the reception-side MFPs 420 when setting the addresses of the reception-side MFPs 420. The processible printer languages may be PCL, PS, Samsung printer language (SPL), and the like. The transmission-side MFP 410 can display the set processible printer languages using a menu, and select a printer language from the menu. Operations subsequent to operation 1100, which include operations 1102 through 1112, are substantially the same as operations 1002 through 1016 of FIG. 10, so they will not be described herein.

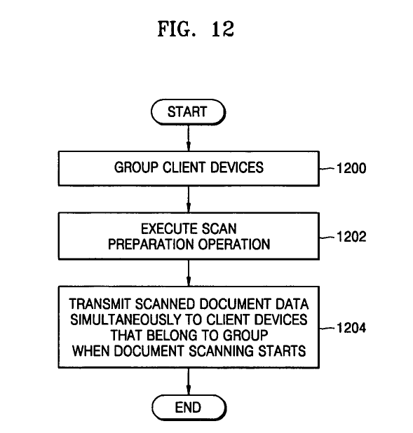

FIG. 12 is a flowchart illustrating a document transmitting method according to still another embodiment of the present invention. The document transmitting method of FIG. 12 will now be described in greater detail in conjunction with FIGS. 5 through 7.

Referring to the method of FIG. 12, the controller 520-6 controls the MFP 520 to group the client devices 500 using IDs, PWs, and group IDs received from the clients in operation 1200. The clients search for a desired MFP 520 by executing a network scan client application as shown in FIG. 6 in the client devices 500 and input their IDs, PWs, and group IDs. Thereafter, the controller 520-6 controls the MFP 520 to produce a transmission list from client devices 500 that have input an identical group ID and store the transmission list in the first database 520-3.

A client device 500 may belong to several groups in some cases. The client devices 500 may also be grouped in advance in operation 1200. Alternatively, the client devices 500 may be grouped temporarily as needed. More specifically, when transmitting scanned document data, the MFP 520 may make a temporary group using some of the client devices 500 and transmit the scanned document data to all of the client devices 500 included in the temporary group. Alternatively, all of the client devices 500 registered in the MFP 520 may automatically belong to any group, so that the scanned document data may be transmitted to all of the client devices 500 without an extra grouping procedure.

After the grouping of the client devices 500, the clients approach the MFP 520 and execute a scan preparation operation in operation 1202. A scan preparation operation denotes a series of processes of inserting a to-be-scanned document into an MFP and inputting an ID, PW, and group ID of a client device to receive a scanned document.

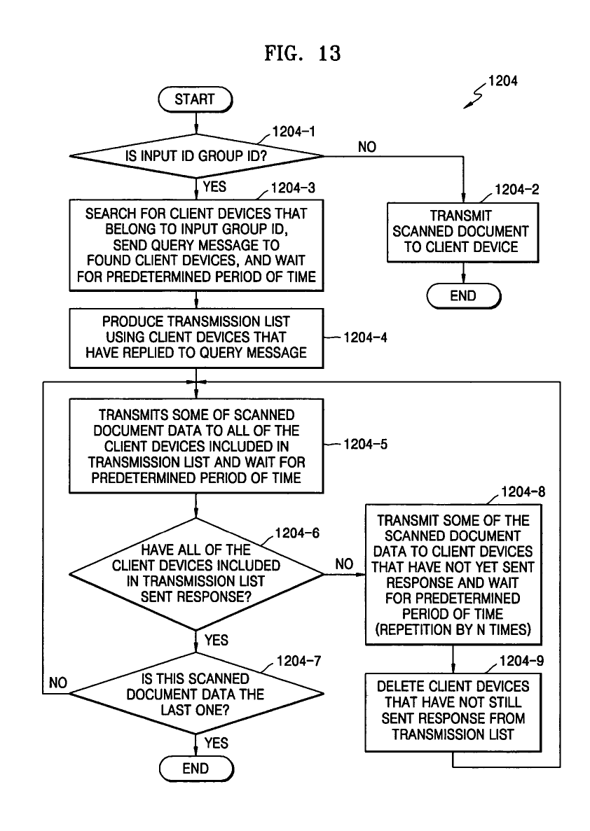

When the scan preparation operation is completed and scanning starts, scanned document data is simultaneously transmitted to the selected client device 500 and other client devices that belong to a group to which the selected client device 500 belongs via the network 510 in operation 1204. Operation 1204 is illustrated in detail in FIG. 13 and will now be described in greater detail.

Referring to the method of FIG. 13, the controller 520-6 determines whether the input ID is an ID of a client device 500 or a group ID in operation 1204-1.

If the input ID is the ID of the client device 500, a document is scanned and the scanned document is transmitted to the client device 500 in operation 1204-2.

If the input ID is the group ID of the client device 500, the controller 520-6 searches for client devices 500 that belong to the input group ID from the first database 520-3, sends a query message to the found client devices 500, and waits for a predetermined period of time in operation 1204-3. This operation is executed to check if the client devices 500 that belong to an identical group operate over the network 510.

After the lapse of the predetermined period of time, the controller 520-6 produces a transmission list using client devices 500 that have replied to the query message and stores the transmission list in the second database 520-4 in operation 1204-4.

Thereafter, the scanning portion 520-5 starts scanning a document, transmits some of scanned document data to all of the client devices 500 included in the transmission list during document scanning, and waits for a predetermined period of time in operation 1204-5.

After the lapse of the predetermined period of time after the transmission of some of the scanned document data, the controller 520-6 determines whether all of the client devices 500 included in the transmission list have sent a reception response informing of a reception of the partial scanned document data in operation 1204-6.

When all of the client devices 500 included in the transmission list have sent the response, the remaining scanned document data is transmitted to all of the client devices 500 included in the transmission list in operation 1204-7.

When all of the client devices 500 included in the transmission list have not yet sent the reception response, some of the scanned document data is again transmitted to client devices 500 that have not yet sent the reception response for a predetermined number of times N, and the controller 520-6 waits a predetermined period of time in operation 1204-8.

Client devices 500 that have still not sent a reception response informing of a reception of the partial scanned document data even after the lapse of the predetermined period of time in operation 1204-8, are then deleted from the transmission list stored in the second database 520-4 and the remaining scanned document data is transmitted to the client devices 500 that have sent the reception response in operation 1204-9.

As described above, in the present invention, a scanned document is simply transceived between MFPs without an intervention of a PC so that users can share information. Functions not supported by a local MFP can be achieved by other selected MFPs over a network, so that the efficiency of office working can be improved. In addition, a scanned document can be transmitted to several MFPs to be printed using a network so that fast and cost-effective document transmission and high quality printing can be achieved as compared with a facsimile, which is a conventional document transmitting method. Further, an MFP can simultaneously transmit a scanned image obtained by one scanning operation to several client devices over a network that need the scanned image. Hence, there is no need to repeat the scanning operation by the number of client devices that need the scanned image, or to re-transmit the scanned image using other networking means (for example, E-mail, or the like). Consequently, document transmission according to the present invention is more convenient for the user.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A document transmitting apparatus comprised of a plurality of image forming devices connected to one another through a network, the apparatus comprising:
a scanning portion for scanning a document and producing image data;
a user interface for selecting a command for performing a function or selecting a desired image forming device;
a network interface connected to the image forming devices over the network for transmitting the scanned document to the selected image forming device;
a display portion; and
a controller for controlling the display portion to display information about the image forming devices existing on the network and transmitting the scanned image data to the selected image forming device via the network.

2. The document transmitting apparatus of claim 1, further comprising a storage portion for storing information about the image forming devices received by the controller.

3. The document transmitting apparatus of claim 2, wherein the information about the image forming devices comprises information about a state of the image forming devices regarding capabilities of printing or storing the scanned document, information about options supported by the image forming devices, and information about locations in the image forming devices where the document can be stored.

4. The document transmitting apparatus of claim 2, wherein the controller comprises:
an information processing portion for processing the information about the image forming devices into displayable information to be transmitted via the network;
a header production portion for producing a header indicating printing or storage and adding the header to the scanned document to be transmitted to the selected image forming device; and
a monitoring portion for monitoring how the selected image forming device which has received the scanned document prints or stores the scanned document.

5. The document transmitting apparatus of claim 4, wherein options can be selected from the displayable information about the image forming devices if the selected image forming device is to print the scanned document.

6. The document transmitting apparatus of claim 4, further comprising:
an authentication portion for selecting a location to store the scanned document from the information about the image forming devices if the selected image forming device is to store the scanned document, comparing an input password with a predetermined password, and authenticating the storage of the scanned document in the selected location if the input password is identical to the predetermined password.

7. The document transmitting apparatus of claim 5, wherein the header production portion is configured to produce the header using the selected option information if the selected image forming device is to print the scanned document, or produce the header using the selected location information if the selected image forming device is to store the scanned document.

8. An apparatus for transmitting scanned document data to an image forming device selected from reception-side image forming devices existing over a network, the apparatus comprising:
a user interface for receiving a command to transmit the scanned document data to the reception-side image forming devices, a command to set addresses for the reception-side image forming devices, and a command to select image forming devices to receive the scanned document data;
a network interface for transmitting scanned image data that the reception-side image forming devices can process to the selected image forming devices; and
a controller for controlling the apparatus to store the addresses of the reception-side image forming devices received via the user interface and information about the printer languages processible by the reception-side image forming devices received via the network interface, and to transmit the encoded scanned document data to the selected reception-side image forming devices via the network.

9. The apparatus of claim 8, wherein the controller is programmable to control the apparatus to divide the addresses of the reception-side image forming devices into at least one group and store the addresses on a group-by-group basis.

10. An apparatus for transmitting scanned document data to an image forming device selected from the reception-side image forming devices over a network, the apparatus comprising:
a user interface for receiving a command to transmit the scanned document data to the reception-side image forming devices, a command to set addresses for the reception-side image forming devices, a command to set printer languages processible by the reception-side image forming devices, and a command to select a reception-side image forming device to receive the scanned document data;
a network interface for transmitting scanned document data encoded in the processible printer languages to the selected image forming device;
a data production and processing portion for encoding the scanned document data in the printer language processible by the selected image forming device; and
a controller for controlling the apparatus to store information about the addresses of the reception-side image forming devices and the printer languages processible by the reception-side image forming devices which is received via the user interface, and to transmit the encoded scanned document data to the selected reception-side image forming device via the network.

11. The apparatus of claim 10, wherein the controller is programmable to control the apparatus to divide the addresses of the reception-side image forming devices into at least one group and store the addresses on a group-by-group basis.

12. A document transmitting apparatus which is comprised of an image forming device that communicates with client devices via a network, the apparatus comprising:
a first database for storing at least one of identifiers, passwords, and group identifiers of the client devices input by clients;
an input portion for receiving an identifier of a group to receive scanned document data;
a second database for storing a transmission list of client devices to receive scanned document data;
a transmission portion for simultaneously transmitting the scanned document data to all of the client devices included in the transmission list; and
a controller for controlling the apparatus to produce the transmission list from client devices that have replied to a query message transmitted before transmission of the scanned document data among client devices having the received group ID and store the transmission list in the second database, to transmit some of the scanned document data to all of the client devices included in the transmission list when scanning starts, to delete client devices from the second database that have not sent a response informing of a reception of the partial scanned document data, and to transmit the remaining scanned document data to client devices that have sent the response.

13. A document transmitting method, comprising the steps of:
receiving a user command for image forming devices existing over a network to print or store a scanned document;
displaying information regarding the image forming devices and receiving a signal for selecting an image forming device to print or store the scanned document from the image forming devices over the network;
receiving a signal for selecting options for printing the scanned document from among the information or authenticating storage of the scanned document; and
scanning the document and transmitting the scanned document to the selected image forming device.

14. The document transmitting method of claim 13, further comprising the step of receiving a result of printing or storage of the scanned document by the selected image forming device.

15. The document transmitting method of claim 13, wherein the displayed information regarding the image forming devices comprises information about states of the image forming devices regarding capabilities of printing or storing the scanned document, information about options supported by the image forming devices, and information about locations in the image forming devices where the document can be stored.

16. The document transmitting method of claim 15, wherein the step of authenticating the storage of the document comprises the steps of:
selecting an image forming device having a document-storable location by referring to the displayed information about the image forming devices;
comparing a password input with a predetermined password to receive an authentication about the use of the document-storable location in the selected image forming device; and
authenticating the storage of the scanned document in the document-storable location if the input password is identical to the predetermined password or displaying an error message if the input password is not identical to the predetermined password.

17. The document transmitting method of claim 13, wherein the step of transmitting the scanned document to the selected image forming device comprises the step of:
producing and adding a header indicating one of document printing and document storage to the scanned document to be transmitted to the selected image forming device.

18. The document transmitting method of claim 17, wherein the header is produced using the selected option information if the selected image forming device is to print the scanned document, or the header is produced using the selected location information if the selected image forming device is to store the scanned document.

19. A method of transmitting scanned document data to an image forming device selected from the reception-side image forming devices existing over a network, the method comprising:
setting addresses for the reception-side image forming devices;
receiving processible printer languages from the reception-side image forming devices via the network;
receiving a signal for selecting a reception-side image forming device to which the scanned document data is to be transmitted among the reception-side image forming devices existing over the network; and
encoding a scanned document in printer languages processible by the selected reception-side image forming device and transmitting the encoded scanned document to the selected reception-side image forming device.

20. The method of claim 19, wherein the step of setting the addresses for the reception-side image forming devices comprises the step of dividing the addresses of the reception-side image forming devices into at least one group.

21. A method of transmitting scanned document data to a reception-side image forming device selected from the reception-side image forming devices existing over a network, the method comprising:
receiving a signal for setting addresses for all of the reception-side image forming devices and a signal for setting printer languages processible by the reception-side image forming devices;
receiving a signal for selecting a reception-side image forming device to which the scanned document data is to be transmitted among the reception-side image forming devices existing over the network; and
encoding a scanned document in printer languages processible by the selected reception-side image forming device and transmitting the encoded scanned document to the selected image forming device.

22. The method of claim 21, wherein the step of receiving the signal for setting the addresses for all of the reception-side image forming devices and the signal for setting the processible printer languages comprises the step of dividing the addresses of the reception-side image forming devices into at least one group.

23. A document transmitting method comprising the steps of:
receiving at least one of identifiers, passwords, and group identifiers of a plurality of client devices from a plurality of clients and grouping client devices that have an identical group identifier; and
inputting an identifier of a group to receive scanned data and transmitting scanned document data to all client devices that belong to the group with the input group identifier when scanning starts.

24. The method of claim 23, wherein the clients simultaneously input identifiers of a plurality of groups.

25. The method of claim 23, wherein the step of transmitting the scanned document data to all the client devices belonging to the group with the input group identifier comprises the steps of:
producing a transmission list from client devices among the client devices belonging to the group with the input group identifier that have replied to a query message transmitted before scanning;
transmitting some of the scanned document data to all of the client devices included in the transmission list when scanning starts and waiting for a response indicating a reception of the partial scanned document data; and
transmitting the remaining scanned document data to client devices that have sent the response.

26. The method of claim 25, wherein client devices that have not sent the response after the partial scanned document data is transmitted a predetermined number of times are deleted from the transmission list.

27. The document transmitting apparatus of claim 6, wherein the header production portion is configured to produce the header using the selected option information if the selected image forming device is to print the scanned document, or produce the header using the selected location information if the selected image forming device is to store the scanned document.
